(19) United States
(12) Patent Application Publication
(10) Pub. No.: US 2022/0260533 A1
(43) Pub. Date: Aug. 18, 2022

(54) CONSTANT ANALYTE VELOCITY FOR IMPROVED GAS CHROMATOGRAPHY SEPARATION

(71) Applicant: BRIGHAM YOUNG UNIVERSITY, Provo, UT (US)

(72) Inventors: H. Dennis Tolley, Mapleton, UT (US); Samuel Avila, Provo, UT (US); Brian D. Iverson, Provo, UT (US); Aaron Hawkins, Provo, UT (US); Milton L. Lee, Pleasant Grove, UT (US)

(21) Appl. No.: 17/676,104

(22) Filed: Feb. 18, 2022

Related U.S. Application Data
(60) Provisional application No. 63/151,053, filed on Feb. 18, 2021.

(51) Int. Cl. G01N 30/32

(52) U.S. Cl. CPC G01N 30/32; G01N 2030/025

(57) ABSTRACT

The present invention is a system and method for significantly improving gas chromatography resolution using a dynamic and non-linear thermal gradient along the entire column length and is achieved by decreasing the velocity of analytes when approaching the back end of the capillary column in order to compensate for an increase in velocity of carrier gas as the carrier gas expands when approaching the back end, and wherein the thermal gradient is selected so that the analyte achieves a constant velocity through the capillary column.

### BACKGROUND

### Field of the Invention

This invention relates generally to gas chromatography. More specifically, the invention relates to a system and method for enhancing the ability of a gas chromatographic system to identify compounds through improved chromatography separations by keeping the analyte velocity relatively constant as the analytes transit through a capillary column.

### Description of Related Art

Benefits of gas chromatography (GC) measurements may include high resolution, low limits of detection, uniform peak shape, high efficiency/peak capacity, and short analysis time. These abilities have been achieved by making refinements in GC components and operating parameters over the years.

For example, the concept of applying a temperature gradient along the column length to focus analyte peaks was introduced. A negative thermal gradient along the column length causes each analyte band to experience a temperature range from higher to lower across the band. Because analyte molecules at lower temperatures have higher retention, molecules at the front of the analyte band move more slowly compared to molecules at the rear of the band, creating a compression or sharpening of the analyte peak.

Previous studies have shown that the resolution obtained in thermal gradient GC cannot exceed the resolution in an ideal, basic GC separation (i.e., one with a perfect injection and no velocity gradients). The ideal, basic separation is not possible to achieve with current instrumentation because any drop in pressure creates a mobile phase velocity gradient.

In theory, a second gradient field (from a thermal gradient or stationary phase thickness distribution for example) can be added to the system to reduce the effects of the non-ideal conditions. When thermal gradient GC is experimentally compared to temperature programmed GC, improved resolution and lower elution temperatures can be observed under certain experimental conditions.

While various theoretical models have been developed to better understand the mechanics governing conventional GC Operating conditions (i.e., isothermal and temperature programmed) these models ignore thermal gradient possibilities. A theoretical model based on continuum fluid mechanics was developed that accommodates a thermal gradient boundary condition; however, no conclusions were provided regarding thermal gradient GC performance relative to conventional heating conditions.

In recent work, the inventors developed a transport model that was used to simulate the stochastic movement of molecules in GC separations. In this model, individual molecules are allowed to experience different retention and dispersion behaviors based on column position and temperature, making it possible to simulate thermal gradient GC conditions. Column parameters that are dependent on temperature and, therefore, position and time in a thermal gradient include mobile phase pressure (p_{x,t}), mobile phase velocity (u_{x,t}), change in entropy (ΔSₓ), change in enthalpy (ΔHₓ), and retention factor (k_{x,t}).

Dispersion and retention parameters for three hydrocarbons (n-dodecane, n-tridecane, and n tetradecane) evaluated in the model were calibrated using experimental isothermal separation data and validated against experimental thermal gradient and temperature programmed GC separations. Retention time errors were less than 4.2% for thermal gradient GC and less than 2.6% for temperature programmed GC. Maximum dispersion errors were less than 5.8% for thermal gradient GC and less than 15.4% for temperature programmed GC.

Using this stochastic approach, analyte peak characteristics (i.e., velocity, width, temperature, retention factor, etc.) at any time or position in the column can be determined under any given column conditions. Interrogation in modeling results provides an advantage over experimental analysis is by offering understanding of separation characteristics along the column length, whereas experimental measurements only provide information at the end of the two columns. A more complete understanding of the separation behavior in GC provided by a transport model can improve the optimization of column conditions and parameters.

Accordingly, it would be an advantage over the prior art to demonstrate that improvements in resolution are shown to occur by reducing the effects of the mobile phase velocity gradient on analyte velocity. It would also be an advantage to show the advantages of a dynamic thermal gradient as compared to a static thermal gradient. Finally, it would be an advantage to demonstrate the advantages of implementation of the invention in a planar topology as compared to a three dimensional column.

### BRIEF SUMMARY

The present invention is a system and method for significantly improving gas chromatography resolution using a dynamic and non-linear thermal gradient along the entire column length and is achieved by decreasing the velocity of analytes when approaching the back end of the capillary column in order to compensate for an increase in velocity of carrier gas as the carrier gas expands when approaching the back end, and wherein the thermal gradient is selected so that the analyte achieves a constant velocity through the capillary column.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a planar surface of a substrate showing a capillary column formed in the shape of a spiral.

FIG. 2 is a top chromatographic view of the planar surface of FIG. 1 showing a possible thermal gradient.

FIG. 3 is a different planar substrate that shows the capillary column in a serpentine shape

FIG. 4 is a graph showing possible thermal gradients.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

As is known to those skilled in the art, GC is performed using a capillary column. The capillary column includes a polymer coating on the inside wall that is cross-linked and bonded to the inside of the column and is known as the stationary phase. The stationary phase is a selective coating that separates the compounds or analytes. The mobile phase of the GC is a gas which carries the sample through the capillary column. The mobile phase may be a gas such as helium, hydrogen or nitrogen.

At an injection port of the GC, the sample is inserted into the capillary column. The injection port is hot in order to vaporize the sample which may be a mixture of a liquid solvent and dissolved analytes, or it may already be in a gas phase. The sample is then transported through the capillary column by the mobile phase. AS the sample is transported, analytes are typically separated according to vapor pressure and the selectivity of the stationary phase. The analytes are sent to a GC detector as they elute from the capillary column. The GC detector may be any appropriate type, including a mass spectrometer, flame ionization detector, etc.

There are essentially two different ways to achieve separation of analytes using GC. The first method is to choose the selectivity of the stationary phase. Different analytes will separate using different compositions of the stationary phase. The second method is to improve efficiency and make the analyte peaks narrower.

In the first method, the stationary phase is changing the relative positions of the analytes as they elute from the capillary column. In the second method, the peaks are being narrowed. The present invention uses the second method by using a thermal gradient along the capillary column.

Operation of the GC capillary column is performed using a linear velocity of carrier gas in the mobility phase. For example, you may have a linear velocity of somewhere between 35 and 100 centimeters per second.

To cause the carrier gas to flow through the capillary column it is pressurized at the injection port. Many different values of pressures may be used, but they are typically not very high. The velocity may depend on the length of the capillary column being used which may vary from a few meters up to 100 meters or more. The longer the capillary column, the higher the pressure that is needed at the front of the capillary column in order to obtain the desired linear velocity of the carrier gas.

At the front of the capillary column, and for most of the column length, the linear velocity is typically constant. However, the velocity may change near the end of the capillary column. This is because the end of the capillary column is at atmospheric pressure.

It is understood that most of the pressure drop in the capillary column is at about the last 20% to 30% of the column. What is important to understand is that when the capillary column begins to depressurize, the gas begins to expand resulting in an increase in the linear velocity. This increase in velocity can be substantial. The problem with the increase in velocity is that the analytes change velocity as well which is undesirable because analytes may no longer have sufficient time to interact with stationary phase.

Accordingly, there is an optimum velocity for the analytes to move through the capillary column in order to achieve separation of the compounds. If this optimum velocity is created at the front of the capillary column, the velocity has substantially increased by the time the back of the capillary column is reached. The result is a decrease in resolution of the analytes because the peaks are now broader because of insufficient time to interact with the stationary phase. Thus, the efficiency of the GC is substantially reduced.

A typical GC capillary column may be put in an oven so that it operates isothermally, or it may utilize a temperature program which raises the temperature at some predetermined rate. The point being that the entire capillary column is at the same temperature, and thus resulting in the inefficiency at the end of the capillary column.

However, by utilizing a thermal gradient along the length of the capillary column, it was discovered that it is possible to increase efficiency at the end of the capillary column. This is accomplished by slowing the linear velocity of the analytes but not changing the linear velocity of the carrier gas. The thermal gradient is used to change the velocity of the analytes which does not affect the increasing velocity of the carrier gas.

In other words, by changing the thermal gradient in a dynamic way and not a static way, the thermal gradient can be used to offset the increase in velocity of the carrier gas. Thus, by decreasing the volatility of the analytes by decreasing the temperature of the sample, the analytes have more time to react with the stationary phase and are thus compensating for the increase in velocity of the mobile phase.

The result of dynamically changing the thermal gradient of the capillary column is that the invention is able to achieve a constant or near constant analyte velocity for the entire length of the capillary column. For the purposes of this document, the phrase “constant analyte velocity” shall be considered to include velocities that are also near constant. Constant and near constant velocities shall be considered those velocities that enable the GC to achieve compression or sharpening of the analyte peaks.

One aspect of the invention that may not be readily apparent is that the dynamic thermal gradient may therefore not be a linear thermal gradient. A linear thermal gradient may not match the gradual decrease in velocity that is needed for the analyte. That is because the increase in the velocity of the mobile phase may not be linear. Thus, by creating the correct non-linear dynamic thermal gradient profile, the analytes may achieve the desired constant or near constant velocity that may result in improved gas chromatography separation and thus higher resolution and increased efficiency of the GC.

It should also be understood that while a non-linear thermal gradient is essential to achieve constant or near constant velocity of the analyte through the GC capillary column, the invention may still utilize temperature programming. Tus, the temperature of the capillary column may be increased uniformly while still maintaining the desired non-linear thermal gradient temperature profile on the capillary column.

The specific hardware that is used for the GC is another aspect of the present invention. A GC may be implemented using various hardware topologies for the capillary column, and thus should be considered to be within the scope of the present invention.

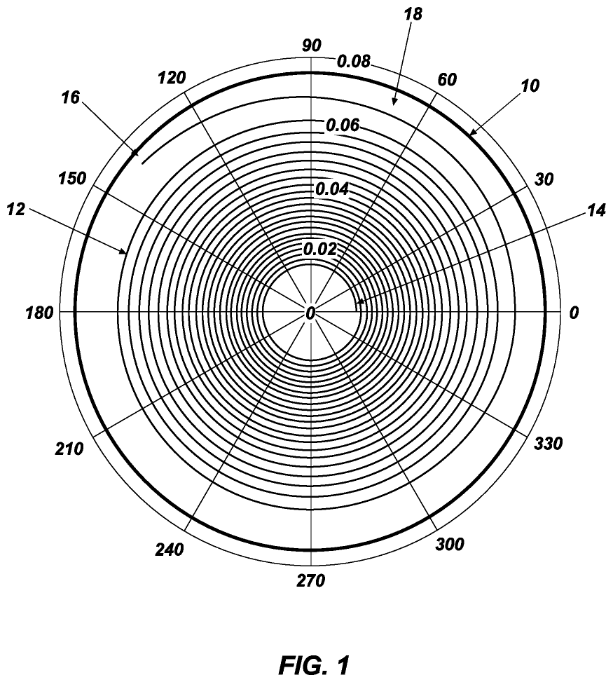

FIG. 1 is a top view of a first embodiment of the invention. The first embodiment is a planar surface 10 of a substrate. Any appropriate thermally conductive material may be used for the planar surface 10 substrate. The planar surface must be capable of withstanding the temperatures that are typically used to heat the capillary column.

The planar surface includes a capillary column 12 formed in the shape of a spiral. The capillary column 12 includes a front end 14 at the center of the planar surface 10 and a back end 16 where the analytes are eluted.

One advantage of the planar surface 10 having a spiral capillary column 12 is that it is conducive to the formation of the desired thermal temperature gradient for the capillary column. For example, the highest temperature will be at the front end 14 of the capillary column 12. Thus, at least one heating element disposed under the center of the planar surface will heat the desired area of the capillary column 12.

The capillary column 12 may be disposed directly on a top surface 18 of the planar surface 10. The top surface 18 may be etched to create a pathway for the capillary column 12. The capillary column 12 may be glued to the top surface using any appropriate adhesive.

It should be understood that the exact length of the capillary column 12 may be adjusted as needed, as well as the exact dimensions of the planar surface 10.

While the capillary column 12 is disposed on the top surface 18, one or more heating elements may be disposed on the opposite bottom surface (not shown) of the planar surface 10.

The number of heating elements may vary in order to achieve the desired thermal gradient for the capillary column 12. The planar surface 10 may be modified in order to assist with creating the desired thermal gradient. For example, insulation may be disposed on a portion of the bottom surface. The insulation could enable portions of the planar surface to retain heat and other portions to lose heat faster. Thus, insulation could be used extending from the center of the planar surface and then end before reaching the edges, thus allowing the edges to cool faster.

Another aspect of the spiral capillary column 12 is the spacing of the capillary column. For example, note that the spacing between the loops of the capillary column 12 gets wider and wider as the capillary column 12 moves from the center of the planar surface 10 to the outer edge. This variable spacing may also be used to achieve the desired thermal gradient profile for the capillary column 12.

It is noted that the planar surface 10 of the first embodiment may be silicon because of its thermal and conductive properties.

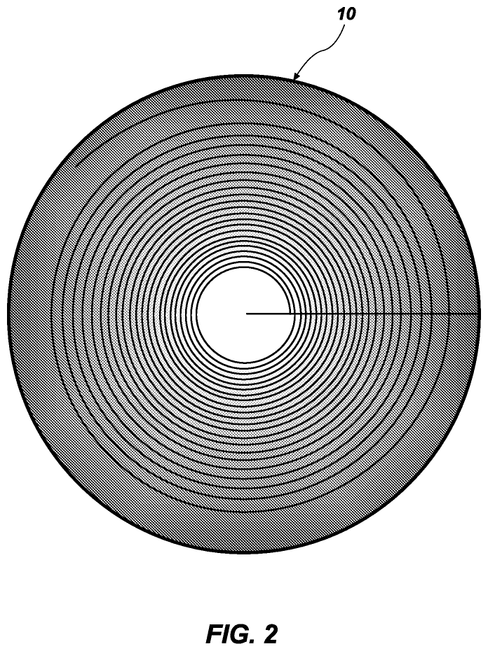

FIG. 2 is a top view of a chromatogram of the planar surface 10 shown in FIG. 1. This chromatogram shows using shading a possible temperature gradient of the planar surface 10, with the highest temperature at the center and the temperatures decreasing as it moves progressively outwards towards the outer edge.

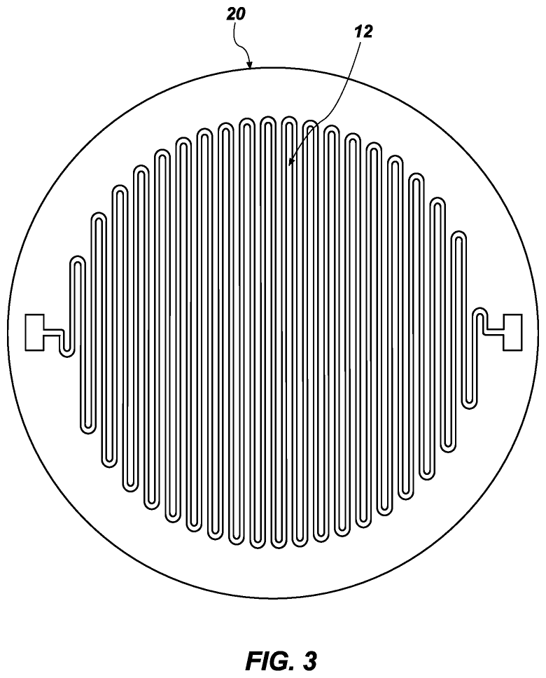

FIG. 3 is a top view of a different planar surface 20. The planar surface 20 has been etched with a different design than in FIG. 1. Instead of a spiral shape, the pathway for the capillary column 12 is shown as being serpentine. It should be understood that there are numerous shapes for the pathway of the capillary column 12 that may all fit on the planar surface 10, 20 and should be considered to be within the scope of the invention.

Wile the spacing of the capillary column 12 appears to be uniform, the spacing may be adjusted to achieve the desired thermal gradient profile. Similarly, insulation may be disposed on a bottom surface (not shown) of the planar surface 20 and used to achieve the desired thermal gradient profile by keeping heat and releasing heat where needed.

The transport model simulates the positions of a selected number of molecules for each analyte band at each time step. The velocity of each molecule is calculated using the mobile phase velocity and molecule retention factor as a function of column position. An additional random movement is applied to each molecule to represent band dispersion due to molecular diffusion and resistance to mass transfer. To calibrate the transport model, parameters governing retention and dispersion are fit to isothermal experimental data. This modeling approach allows for variable conditions (temperature, pressure, etc.) to be applied to individual molecules.

A static thermal gradient does not improve resolution equally for all analytes, which highlights the need for a dynamic thermal gradient. An optimum dynamic thermal gradient should result in constant analyte velocities for those analytes that are actively being separated (i.e., analytes that have a low retention factor). The average separation temperature for each analyte is used to determine the thermal gradient profile at different times in the temperature ramp.

A transport model for analyzing movement of individual molecules was developed for analyzing performance of the thermal gradient. Because the movement of each molecule is independent of other molecules, the effects of position-dependent variables (such as pressure, temperature, mobile phase velocity, etc.) can be easily simulated and evaluated. This transport model was calibrated for three analytes using experimental isothermal separation data and validated against experimental thermal gradient and temperature programmed GC separations. Using this stochastic approach, analyte peak characteristics (i.e., velocity, width, temperature, retention factor, etc.) at any time or position in the column may be determined under any given column conditions. This model was later employed to compare GC separations under isothermal and static thermal gradient conditions. A static thermal gradient may improve resolution up to 8.6% over isothermal resolution for the simulated conditions. The gain from using a static thermal gradient may be dependent on the GC conditions used (e.g., isothermal temperature, pressure, column length, etc.). The optimal thermal gradient for an analyte creates conditions for a constant analyte velocity at all column positions. Analytes do not necessarily share the same optimal, static thermal gradient; in fact, an optimal thermal gradient for one analyte pair may reduce resolution for a different pair. In practical terms, this means that a static thermal gradient should not be used unless the analytes of interest have similar, approximately known, retention factors.

Unlike a static thermal gradient, a dynamic thermal gradient allows for temporally varying column temperatures. A traditional temperature programmed condition is an example of dynamic heating conditions. A temporally varying temperature is used to reduce analysis time and can improve the limit of detection for analytes; note that resolution typically decreases when the column temperature is ramped in time. A dynamic thermal gradient can shift to accommodate the analytes actively being separated and improve resolution for all analytes as compared to a temperature programmed separation.

Because an optimal, static thermal gradient increases resolution over an isothermal temperature profile, the dynamic thermal gradients explored here also use the same shape as optimal, static thermal gradients. These gradients are characterized by a mostly constant slope over much of the capillary column length that then begins to decrease more rapidly near the column exit to account for the increasing velocity near the back end. The shape of the dynamic thermal gradient is the same for any instant in time, but the column temperatures are increased over time so that they maintain the same gradient.

Because the temperature programmed and dynamic thermal gradient simulations in this work share the same temperature ramp rates, the results presented could also be applied to the optimal temperature ramp. It is anticipated that the dynamic thermal gradient that is ramped using the optimal rate will exceed performance of the temperature programmed result (at the same optimal rate) by approximately the same amount as shown here. The selection of which optimal thermal gradient profile to use is discussed below as each analyte has a distinct optimal thermal gradient for any given GC conditions.

Motivation for using a dynamic thermal gradient is to apply any benefits in separation to all analytes equally, which is not achievable using a static thermal gradient. Using the transport model for the industrial column, the effect of a static thermal gradient (not changing temporally) on the resolution for a wider range of analytes can be observed.

A static thermal gradient may be created for each analyte at a specific temperature. At lower temperatures, the static thermal gradient slope is small, because low temperatures have a larger effect on retention. The slope of the static thermal gradient increases for higher temperatures because retention factors are small at high temperatures.

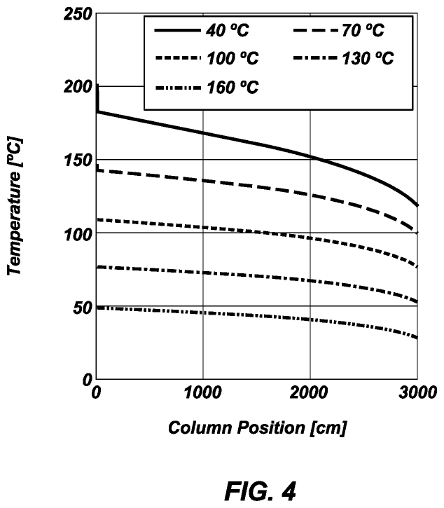

FIG. 4 shows the optimal, static thermal gradient for C 12 at temperatures from 40-160 Celsius. If all analytes in a sample share a similar retention factor, then the optimal dynamic thermal gradient would ramp through each of the temperatures shown in FIG. 4. This would improve resolution between analytes by creating conditions for an average analyte velocity at all times during the ramp even though average velocities would not be constant in time.

A dynamic thermal gradient that creates more ideal separation conditions for the analytes that are moving will improve separation for every analyte. Two temperature programmed simulations were performed and temperatures for each analyte were recorded. For each analyte, an equivalent non-linear, static thermal gradient was calculated at its average temperature, a thermal gradient created to match this temperature will create near-constant analyte velocities for the longest amount of time.

A dynamic thermal gradient with a fixed profile may provide resolution improvements for all analytes. An optimal, dynamic thermal gradient changes conditions in the column to approximate ideal conditions for all analytes although conditions are non-ideal at the column entrance and exit. The optimal, dynamic thermal gradient uses the profile from an optimal, static thermal gradient at the average temperature for the temperature ramp. That profile is fixed and then uniformly adjusted to be equivalent to a temperature programmed separation at any time. Analytes under dynamic thermal gradient heating also experience lower temperatures (a difference of 26-32° C.) than under temperature programmed heating. The transport model simulations indicate that resolution improvements of up to 15% are achievable over temperature programmed GC for the conditions simulated.

It should be recognized that a separate heating element may also be disposed under the entire planar surface. The separate heating element may be used to uniformly raise the entire thermal gradient without actually changing the shape of the thermal gradient. Thus, the thermal gradient profile is raised in temperature without affecting the ability of the analytes to still move at a constant velocity through the capillary column.

Another aspect of the invention relates to the heating elements under the planar surface of the GC. The heating elements may be applied to the bottom surface of the planar surface 10 using any appropriate technique or system. For example, the heating elements may be applied using silk screening onto the bottom surface. To obtain the desired thermal gradient, the system may also use active cooling elements under the planar surface.

Another aspect of the first embodiment of the invention relates to a minimum temperature of the temperature gradient. It is important that the lowest temperature of the temperature gradient not descend below a temperature that is necessary to keep the analyte from reaching equilibrium within the capillary column. If the temperature drops low enough, the stationary phase would be capable of stopping movement of the analyte, thus the thermal gradient must take that into consideration when determining the highest temperature of the thermal gradient.

It is noted that while the first embodiment of the invention is taught as using a planar surface for the capillary column, it may be possible to form the surface for the capillary column on a surface that is not planar. While the planar surface is efficient and makes for a compact GC, other surface should be considered to fall within the scope of the invention.

In summary, the first embodiment of the invention is directed to a method for improving gas chromatography separation, said method comprising providing a surface for a capillary column; disposing the capillary column on the surface; disposing at least one heating element under the surface such that the at least one heating element is disposed under at least a front end of the capillary column where a sample is injected into the capillary column, and wherein the at least one heating element creates a thermal gradient between the front end of the capillary column and a back end where analytes are eluted; injecting a carrier gas into the front end of the capillary column in order to transport the analytes from the front end to the back end; and wherein the thermal gradient is non-linear such that the analytes in the capillary column will decrease in velocity when approaching the back end in order to compensate for an increase in velocity of carrier gas as the carrier gas expands when approaching the back end, and wherein the thermal gradient is selected so that the analyte achieves a constant velocity through the capillary column.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A method for improving gas chromatography separation, said method comprising:
providing a surface for a capillary column;
disposing the capillary column on the surface;
disposing at least one heating element under the surface such that the at least one heating element is disposed under at least a front end of the capillary column where a sample is injected into the capillary column, and wherein the at least one heating element creates a thermal gradient between the front end of the capillary column and a back end where analytes are eluted;
injecting a carrier gas into the front end of the capillary column in order to transport the analytes from the front end to the back end; and
wherein the thermal gradient is non-linear such that the analytes in the capillary column will decrease in velocity when approaching the back end in order to compensate for an increase in velocity of carrier gas as the carrier gas expands when approaching the back end, and wherein the thermal gradient is selected so that the analyte achieves a constant velocity through the capillary column.

2. The method as defined in claim 1 wherein the method further comprises:
forming the surface as a planar surface;
etching a pathway into the planar surface; and
attaching the capillary column to the etched pathway using an adhesive.

3. The method as defined in claim 2 wherein the method further comprises etching a spiral pathway into the planar surface such that the front end of the capillary column is at a center of the planar surface and the back end is at an outer edge of the planar surface.

4. The method as defined in claim 3 wherein the method further comprises adjusting a width between loops made by the spiral pathway such that spacing between loops may be adjusted to affect the thermal gradient of the capillary column by increasing the width between successive loops so that the outer loops of the spiral pathway are further apart than loops near the center of the planar surface.

5. The method as defined in claim 4 wherein the method further comprises disposing a different heating element under the entire planar surface to thereby raise the entire thermal gradient uniformly without changing the shape of the thermal gradient.

6. The method as defined in claim 2 wherein the method further comprises disposing insulation on selected portions of the bottom surface of the planar surface, wherein the insulation modifies the thermal gradient of the capillary column by keeping heat in the planar surface wherever it is disposed.

7. The method as defined in claim 2 wherein the method further comprises etching a serpentine pathway into the planar surface such that the front end of the capillary column is at a first edge of the planar surface and the back end is at a different edge of the planar surface.

8. A method for obtaining a constant velocity of analytes through a capillary column using a non-linear thermal gradient, said method comprising:
providing a surface for a capillary column;
disposing the capillary column on the surface;
disposing at least one heating element under the surface such that the at least one heating element is disposed under at least a front end of the capillary column where a sample is injected into the capillary column, and wherein the at least one heating element creates a thermal gradient between the front end of the capillary column and a back end where analytes are eluted;
injecting a carrier gas into the front end of the capillary column in order to transport the analytes from the front end to the back end; and
wherein the thermal gradient is non-linear such that the analytes in the capillary column will decrease in velocity in a non-linear manner when approaching the back end in order to compensate for an increase in velocity of the carrier gas as the carrier gas expands when approaching the back end, and wherein the thermal gradient is selected so that the analyte achieves a constant velocity through the capillary column.

9. A system for improving gas chromatography separation, said method comprising:
providing a surface for a capillary column;
disposing the capillary column on the surface;
disposing at least one heating element under the surface such that the at least one heating element is disposed under at least a front end of the capillary column where a sample is injected into the capillary column, and wherein the at least one heating element creates a thermal gradient between the front end of the capillary column and a back end where analytes are eluted;
injecting a carrier gas into the front end of the capillary column in order to transport the analytes from the front end to the back end; and
wherein the thermal gradient is non-linear such that the analytes in the capillary column will decrease in velocity when approaching the back end in order to compensate for an increase in velocity of carrier gas as the carrier gas expands when approaching the back end, and wherein the thermal gradient is selected so that the analyte achieves a constant velocity through the capillary column.
